(19) United States
(12) Patent Application Publication
(10) Pub. No.: US 2025/0063458 A1
(43) Pub. Date: Feb. 20, 2025

(54) CONDITIONAL HANDOVER

(71) Applicant: Nokia Technologies Oy, Espoo (FI)

(72) Inventors: Arled PAPA, Munich (DE); Ugur Baran ELMALI, Munich (DE); Muhammad NASEER-UL-ISLAM, Munich (DE); Philippe GODIN, Massy (FR); Ahmad AWADA, Munich (DE); Ömer BULAKCI, Munich (DE); György Tamás WOLFNER, Budapest (HU)

(21) Appl. No.: 18/804,836

(22) Filed: Aug. 14, 2024

(30) Foreign Application Priority Data
Aug. 16, 2023 (GB) 2312481.1

(51) Int. Cl. H04W 36/36; H04L 41/5009; H04W 36/30

(52) U.S. Cl. CPC H04W 36/362; H04W 36/30; H04L 41/5012

(57) ABSTRACT

There is herein disclosed a method for receiving, from a radio access network node, a conditional handover configuration for a plurality of target cells and a radio condition for conditional handover of the UE for a plurality of target cells. The method further comprises receiving, from the radio access network node, an indication that the UE is allowed to select and connect to a preferred target cell from the plurality of target cells. The method further comprises selecting the preferred target cell from the plurality of target cells based on network slice area of service availability information for each target cell configured at the UE and the radio condition and transmitting, a request to connect to the preferred target cell.

### CROSS-REFERENCE TO RELATED APPLICATIONS

This application claims the benefit of priority of United Kingdom Patent Application No. 2312481.1 filed Aug. 16, 2023, which is hereby incorporated by reference.

### FIELD

Example embodiments may relate to apparatus, methods and/or computer programs for performing a conditional handover. In particular, there is herein provided a user equipment and a network node for performing a conditional handover.

### BACKGROUND

In 5G, network slicing allows customized treatment based on customer requirements. Mobile Network Operators can categorize customers into different types, each with specific service needs. This categorization determines which types of network slices each customer is eligible for, based on Service Level Agreements (SLAs) and subscriptions. Each network slice is identified by a unique S-NSSAI, consisting of a Slice/Service Type (SST) field (8 bits) and an optional Slice Differentiator (SD) field (24 bits) to differentiate between slices with the same SST. The S-NSSAI list can contain up to 8 entries. While the network can support numerous slices (hundreds), a user equipment (UE) is not required to simultaneously support more than 8 slices.

A Network Slice Area of Service (NS-AoS) is defined as the area where a UE can access and receive services from a specific network slice, as long as more than zero resources are allocated to that specific network slice in Next Generation Radio Access Network (NG-RAN) cells. Mobile Network Operators configure radio resources for network slices in available areas, while areas where the network slice is not available have zero radio resources. The Access and Mobility Management Function (AMF) optimizes behavior by providing S-NSSAI location availability information for one or more S-NSSAIs to supporting UEs, monitoring S-NSSAI usage, and enforcing NS-AoS. S-NSSAI location availability defines restrictions for using an S-NSSAI in areas where network slice availability does nott match tracking area (TA) boundaries. The AMF decides whether to send location availability information to UEs, indicating the cells where an S-NSSAI is available. This information may be provided by the AMF to the supporting UEs either in the Registration Accept message or in the UE Configuration Command message.

How to steer the UE within network slice the area of service is yet to be determined. One example of a mechanism to keep the UE within the NS-AoS or steer the UE to enter the NS-AoS as long as radio conditions allows is the handover. Conditional Handover (CHO) refers to a type of handover, where the UE is configured with a configuration for a potential target cell and a condition to execute the handover for one or more target cells. The CHO configuration received at the UE from the radio access network node allows the UE to perform a handover without the need to further involve the network, if conditions in another target cell become better than the serving cell in which the UE is currently located. This provides a much more efficient and robust mobility solution for handover, especially in cases when the UE is moving between many different cells. The UE receives a CHO configuration from the network at RRCConfiguration, which includes an execution condition for CHO to take place from a serving cell to a target cell. One example of an execution condition is that the target cell should be better than the serving cell in some way, for example the target cell has a better radio link quality or a better signal strength than the serving cell. Once the UE receives the CHO configuration it begins assessing the execution condition(s) and ceases evaluation once a handover is performed towards a target cell.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is described an apparatus comprising means for receiving, from a radio access network node, a conditional handover configuration for a plurality of target cells and a radio condition for conditional handover of a user equipment, UE, for a plurality of target cells. The apparatus is a UE. The apparatus further comprises means for receiving, from a radio access network node, a conditional handover configuration for a plurality of target cells and a radio condition for conditional handover of the UE for a plurality of target cells. The apparatus further comprises means for receiving, from the radio access network node, an indication that the UE is allowed to select and connect to a preferred target cell from the plurality of target cells. The apparatus further comprises means for selecting the preferred target cell from the plurality of target cells based on network slice area of service availability information for each target cell configured at the UE and the radio condition and transmitting, a request to connect to the preferred target cell.

In some embodiments, the apparatus comprises means for receiving a mapping between a physical cell identifier and a global cell identifier for at least one of the plurality of target cells.

In some embodiments, the mapping is received in a system information block, SIB, sent by the radio access network node.

In some embodiments, the network slice area of service availability information for a target cell comprises information indicating availability or unavailability of at least one network slice at the target cell. The at least one network slice is unavailable at the target cell when the at least one network slice is configured with zero resources at the target cell.

In some embodiments, the apparatus further comprises means for receiving, from the radio access network node, power imbalance information for each of the plurality of target cells.

In some embodiments, the power imbalance information comprises a power difference which the UE can tolerate when comparing a power difference between a first target cell that fulfils at least one radio condition criteria with a second target cell that fulfils the at least one radio condition criteria. The second target cell has more slices available compared to the first cell.

In some embodiments, the selecting comprises determining whether, at a first target cell of the plurality of targets cells, one or more network slices currently in use or allowed to be used by the UE are available based on the network slice area of service availability information for the first target network cell.

In some embodiments, the apparatus further comprises, upon determining that at the first target cell one or more network slices of the UE are unavailable, means for searching for a second target cell from the plurality of target cells. The apparatus further comprises means for determining whether the second target cell satisfies the radio condition for the second target cell and determining whether at the second target cell there are more network slices available than at the first target cell. The apparatus further comprises means for upon determining that the second target cell satisfies the radio condition and determining that the second target cell has more network slices available than the first target cell, selecting the second target cell and connecting to the second target cell, or upon determining that the second target cell does not satisfy the radio condition and/or determining that the second target cell does not have more network slices available than the first target cell, selecting the first target cell and connecting to the first target cell.

In some embodiments, the apparatus further comprises, means for upon determining that the one or more network slices of the UE are unavailable in the first target cell, ranking the plurality of target cells based on the plurality of cells being available within at least one of the following: all network slices allowed by a core network for the UE are available, a maximum number of network slices allowed by the core network for the UE are available compared to the other target cells, network slices categorized as having a high network priority, network slices categorized as having a high priority network slice access stratum group, NSAG and network slices categorized as having a high UE priority. The apparatus further comprises means for selecting a third target cell and connecting to the third target cell, the third target cell having the highest ranking, and connecting to the third target cell.

In some embodiments, the apparatus further comprises, means for upon determining at that the first target cell one or more network slices used or allowed to be used by the UE are unavailable, determining a cell that the UE is connected to and periodically assessing whether the cell meets a predetermined threshold value for the radio condition.

In some embodiments, the apparatus further comprises, means for upon determining that the cell does not meet the predetermined threshold value for the radio condition, selecting and connecting to a fourth target cell of the plurality of cells.

According to a second aspect, there is described an apparatus comprising means for determining a conditional handover configuration for a plurality of target cells and a radio condition for conditional handover of a user equipment, UE, the conditional handover configuration of the plurality of target cells comprising network slice area of service availability information criterion for each of the plurality of target cells. The apparatus further comprises means for adjusting the criterion based on a network slice area of service availability information of the plurality of target cells. The apparatus further comprises means for selecting a preferred target cell based on the criterion and transmitting, to the UE, the selection of preferred target cell. The apparatus according to the second aspect is a radio access network node.

In some embodiments, the apparatus further comprises means for receiving an indication of network slice availability for the plurality of target cells from an access and mobility management function.

In some embodiments, the means for adjusting the criterion is based on the preferred target cell being available within at least one of the following: all network slices allowed by a core network for the UE are available, a maximum number of network slices allowed by the core network for the UE are available compared to the other target cells, network slices categorized as having a high network priority, network slices categorized as having a high priority network slice access stratum group and network slices categorized as having a high UE priority.

In some embodiments, the apparatus further comprises means for transmitting, to the user equipment, information required to complete a conditional handover to the preferred target cell.

In some embodiments, the apparatus further comprises means for receiving a mapping between a physical cell identifier and a global cell identifier for at least one of the plurality of target cells.

In some embodiments, the apparatus the mapping is received in a system information block, SIB, sent by the radio access network node.

In some embodiments, the apparatus further comprises means determining power imbalance information for each of the plurality of target cells.

In some embodiments, the apparatus the power imbalance information comprises a power difference which the UE can tolerate when comparing a power difference between a first target cell that fulfils at least one radio condition criteria with a second target cell that fulfils the at least one radio condition criteria. The second target cell has more slices available compared to the first cell.

According to a third aspect, there is described a method comprising: receiving, from a radio access network node, a conditional handover configuration for a plurality of target cells and a radio condition for conditional handover of the UE for a plurality of target cells, receiving, from the radio access network node, an indication that the UE is allowed to select and connect to a preferred target cell from the plurality of target cells, selecting the preferred target cell from the plurality of target cells based on network slice area of service availability information for each target cell configured at the UE and the radio condition, and transmitting, a request to connect to the preferred target cell.

According to a fourth aspect, there is described a method comprising: determining a conditional handover configuration for a plurality of target cells and a radio condition for conditional handover of a user equipment, UE, the conditional handover configuration of the plurality of target cells comprising network slice area of service availability information criterion for each of the plurality of target cells. The method further comprises adjusting the criterion based on a network slice area of service availability information of the plurality of target cells, selecting a preferred target cell based on the criterion, and transmitting, to the UE, the selection of preferred target cell.

According to a fifth aspect, there is provided a computer program product comprising a set of instructions which, when executed on an apparatus, is configured to cause the apparatus to carry out the method of any preceding method definition.

According to a sixth aspect, there is provided a non-transitory computer readable medium comprising program instructions stored thereon for performing a method of any preceding method definition.

### BRIEF DESCRIPTION OF THE DRAWINGS

Example embodiments will now be described by way of non-limiting example, with reference to the accompanying drawings, in which:

FIG. 1 shows, by way of example, a network architecture of a communication system.

FIG. 2 shows, by way of example, network slice configuration.

FIGS. 3a and 3b shows, by way of example, a conditional handover procedure.

FIG. 4 shows, by way of example, flowchart of a first method.

FIG. 5 shows, by way of example, flowchart of a second method.

FIG. 6a-6c shows, by way of example, a flow chart of a decision-making process for a conditional handover. FIG. 6b focusses on a network-based approach and FIG. 6c focusses on a user equipment-based approach.

FIGS. 7a and 7b shows, by way of example, a flow chart of a decision-making process for a conditional handover. FIG. 7a focusses on a user equipment ranking based approach and FIG. 7b focusses on a user equipment time-based approach.

FIG. 8 shows, by way of example, a block diagram of an apparatus.

### DETAILED DESCRIPTION

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

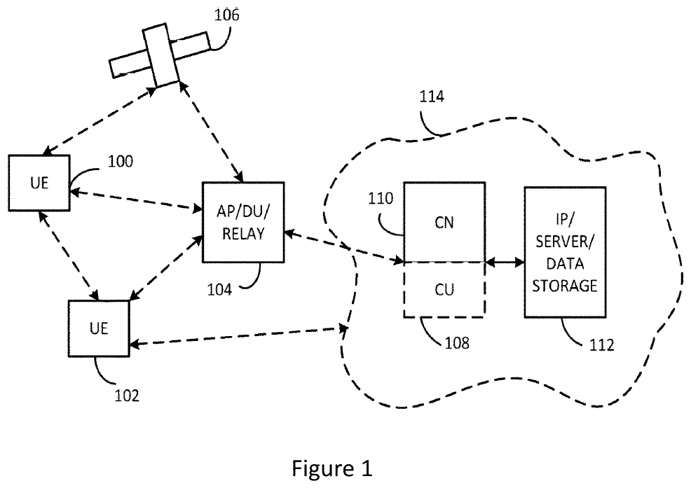

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying core network.

FIG. 1 shows user devices 100 and 102 configured to be in a wireless connection on one or more communication channels in a cell with an access network node (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards a radio access node, RAN, base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilise cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

In the following, embodiments suitable for a networking slicing using conditional handover are disclosed in further detail.

Network slicing is a key 5G feature to support different services using the same underlying mobile network infrastructure. Network slices can differ either in their service requirements like Ultra-Reliable Low Latency Communication (URLLC) and enhanced Mobile Broadband (eMBB) or the tenant that provides those services.

A network slice is uniquely identified via the S-NSSAI (Single-Network Slice Selection Assistance Information). Current 3GPP specifications allow a UE to be simultaneously connected and served by at most eight slices meaning eight S-NSSAIs. On the other hand, each cell may support tens or even hundreds of slices, e.g., in the current specifications a Tracking Area (TA) can support up to 1024 network slices.

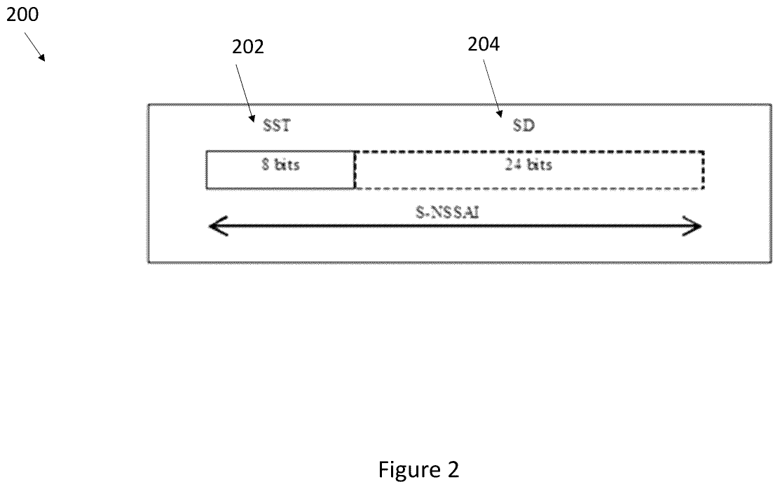

As shown in FIG. 2, the S-NSSAI may include both the Slice Service Type (SST) 202 and the Slice Differentiator (SD) 204 field with a total length of 32 bits or include only the SST field part in which case the length of S-NSSAI is 8 bits only.

The SST field may have standardized and non-standardized values. Values from 0 to 127 belong to the standardized SST range. For instance, SST value of 1 may indicate that the slice is suitable for handling of 5G eMBB, 2 for handling of URLLC, etc. SD is operator-defined only.

3GPP TS 23.501 defines the following.

Network Slice Area of Service: The area where a UE can access and get service of a particular network slice as more than zero resources are allocated to the network slice in the NG-RAN cells.

The network support for a network slice is defined on a per Tracking Area granularity. It may be beneficial to deploy some network slices such that the network slice have a limited geographical availability that is not matching existing tracking area (TA) boundaries.

The operator can in this case decide to change the topology of the Tracking Areas so they match the boundaries of the network slice, or the operator may configure resources for the network slices in the cells of the TA where the network slices are to be available, and in areas of the TAs where the network slice is defined to be not available the cells are configured with zero resources.

The AMF receives from the Operations, Administration, and Maintenance (OAM) the information on availability of a network slice when the granularity is smaller than TA, i.e. if the NS-AoS includes TAs where the network slice is not available in some cells of the TA.

In order to optimize the end-to-end behavior, the AMF can, based on NS-AoS information received from OAM, configure supporting UEs with S-NSSAI location availability information, and the network may need to monitor the S-NSSAI usage and enforce the NS-AoS e.g. if the UE does not support the S-NSSAI location availability information.

S-NSSAI location availability information defines additional restrictions to the usage of an S-NSSAI in TAs where the network slice availability does not match the TA boundaries. The AMF is configured per S-NSSAI whether to send the S-NSSAI location availability information to supporting UEs.

The S-NSSAI location availability information sent to the UE includes, for each applicable S-NSSAI of the Configured NSSAI, Location information indicating the cells of TAs in the Registration Area (RA) where the related S-NSSAI is available if the S-NSSAI is not available in all the cells of the TA.

If the UE has indicated that the UE supports S-NSSAI location availability information in the 5GMM Core Network Capability, the AMF may, based on OAM configuration, configure the UE with S-NSSAI location availability information for one or more S-NSSAIs when the AMF allocates an RA where the network slice availability does not match whole TAs, by including the S-NSSAI location availability information in the registration accept message or the UE configuration command message. A UE that receives S-NSSAI location availability information applies the information as follows.
1. If the S-NSSAI is rejected in the RA or rejected partially in the RA or rejected with a cause code that allows attempting to register the S-NSSAI again, the UE can request the S-NSSAI only if the S-NSSAI location availability information indicates that the S-NSSAI is available at the cell where the UE is camping.
2. If the S-NSSAI is in the partially allowed NSSAI, the UE shall not activate User Plane for any already established packing data unit (PDU) Session with that S-NSSAI if the UE is in a cell within the RA but outside the Location information of the S-NSSAI.
3. If the S-NSSAI is in the partially allowed NSSAI, and the UE in CM-IDLE mode is moved to a cell outside the location information of the S-NSSAI, and the UE has an established PDU Session with that S-NSSAI, the PDU Session is kept.

OAM may configure Radio Resource Management (RRM) policies for S-NSSAIs on a per cell basis, i.e. cells outside the Network Slice Area of Service while in a TA supporting the S-NSSAI are allocated with no RRM resources for the S-NSSAI.

The network may enforce the NS-AoS for an S-NSSAI as follows:
1. The network monitors the validity of the S-NSSAI for UE in CM-CONNECTED state, i.e. as per the location.
2. If the non-supporting UE makes a PDU Session establishment request with an S-NSSAI that is not valid as per the S-NSSAI location availability information, the AMF may reject the NAS Transport message with a back-off timer using S-NSSAI based congestion control as described in clause 5.19.7.4 of 3GPP TS 23.501.
3. If the AMF determines that the UE in CM-CONNECTED has moved outside the NS-AoS, the AMF performs the following logic:
   a) If the non-supporting UE has other S-NSSAI(s) in the allowed NSSAI, then the AMF may update the UE with a UE Configuration Update by removing the S-NSSAI from the Allowed NSSAI (which causes the UE to locally release the PDU Sessions) and removing the S-NSSAI from the Configured NSSAI, and then the AMF requests the SMF to locally release in the network any PDU Sessions with that S-NSSAI.
   b) If the non-supporting UE does not have any other S-NSSAI in the allowed NSSAI, then the AMF may update the UE with a UE configuration update by removing the S-NSSAI from the allowed NSSAI (which causes the UE to locally release the PDU Sessions) and optionally removing the S-NSSAI from the configured NSSAI, and adding a default S-NSSAI to the allowed NSSAI, and then the AMF requests the SMF to locally release in the network any PDU Sessions with the removed S-NSSAI. Alternatively, the AMF requests the SMF to release PDU sessions with that S-NSSAI.

OAM may configure RRM policies for S-NSSAIs on a per cell basis, i.e. cells outside the network slice area of service while in a TA supporting the S-NSSAI are allocated with no RRM resources for the S-NSSAI. The network may enforce the NS-AoS for an S-NSSAI as follows:
1. The network monitors the validity of the S-NSSAI for UE in CM-CONNECTED state, i.e. as per the location.
2. If the non-supporting UE makes a PDU Session establishment request with an S-NSSAI that is not valid as per the S-NSSAI location availability information, the AMF may reject the NAS Transport message with a back-off timer using S-NSSAI based congestion control.
3. If the AMF determines that the UE in CM-CONNECTED has moved outside the NS-AoS, the AMF performs the following logic:
   a) If the non-supporting UE has other S-NSSAI(s) in the Allowed NSSAI, then the AMF may update the UE with a UE Configuration Update by removing the S-NSSAI from the Allowed NSSAI (which causes the UE to locally release the PDU Sessions) and removing the S-NSSAI from the Configured NSSAI, and then the AMF requests the SMF to locally release in the network any PDU Sessions with that S-NSSAI.
   b) If the non-supporting UE does not have any other S-NSSAI in the Allowed NSSAI, then the AMF may update the UE with a UE Configuration Update by removing the S-NSSAI from the Allowed NSSAI (which causes the UE to locally release the PDU Sessions) and optionally removing the S-NSSAI from the Configured NSSAI, and adding a default S-NSSAI to the Allowed NSSAI, and then the AMF requests the SMF to locally release in the network any PDU Sessions with the removed S-NSSAI. Alternatively, the AMF requests the SMF to release PDU Sessions with that S-NSSAI.
   c) For a non-supporting UE that does not have any other S-NSSAI in the Allowed NSSAI nor in the Configured NSSAI, then the AMF indicates to the SMF to release the PDU Session. 4. If the AMF determines that the S-NSSAI becomes valid e.g. the UE has moved into the NS-AoS, the AMF may update the UE with a UCU e.g. including the S-NSSAI in the Configured NSSAI.

### Conditional Handover (CHO)

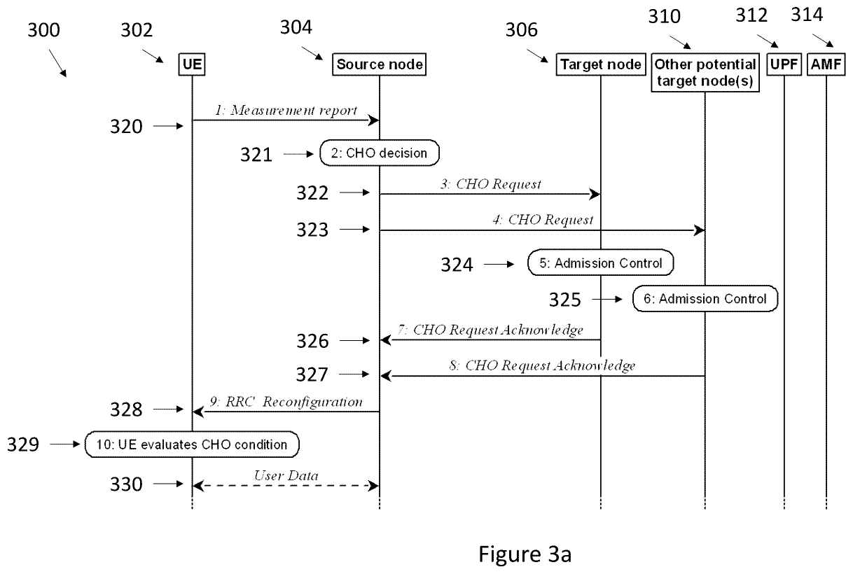

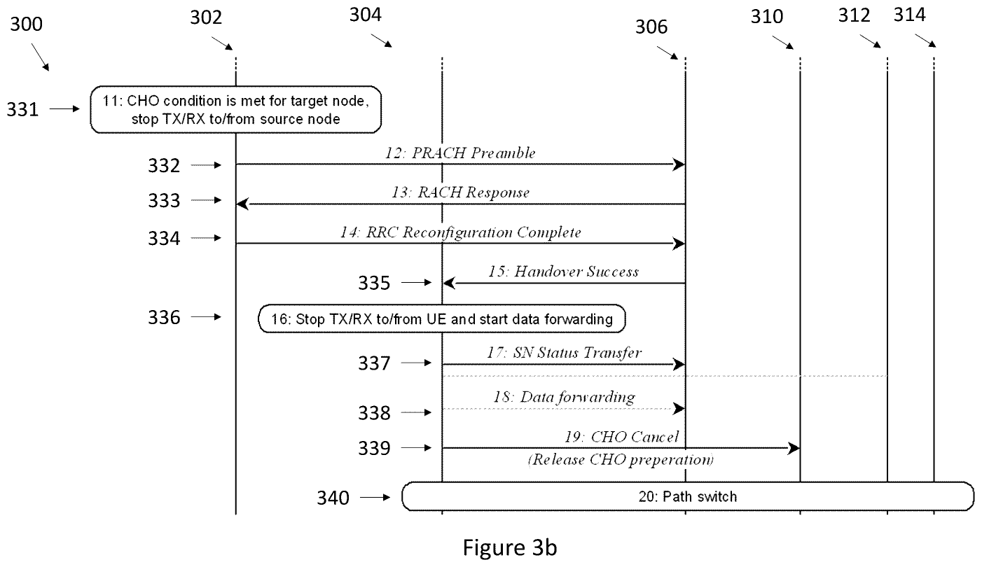

In CHO process, a UE is configured with a CHO configuration for one or more target cells and a CHO condition to execute handover for one or multiple target cells in case that the CHO condition is met. The radio access network node sends RRCReconfiguration message to the UE. The RRCReconfiguration message contains for each of the prepared target cells the CHO configuration and the CHO condition. The UE then evaluates for each of the prepared target cells. The CHO condition may be based on a radio condition and if any of the prepared target cells meets this radio condition then the UE directly handovers to that target cell. The CHO condition may be based on radio measurements of the neighbour cells. A generalized CHO procedure is presented in FIGS. 3A and 3B. FIG. 3A shows the CHO process 300 and FIG. 3B also shows the CHO process, continuing from the end of the process in FIG. 3A.

CHO enables a UE can do the handover autonomously without the need for the source node to trigger (e.g., cause) CHO e.g., after receiving the measurement report. The steps of the CHO procedure shown in FIGS. 3A and 3B are described in the following.

The UE 302 sends a measurement report 320 to a source radio access network node 304 (hereinafter referred to as source node 304) containing the measurement results for neighboring cells. At step 321, the source node 304 identifies the need to trigger (or cause) CHO and requests in steps 322 and 323 target radio access network nodes 306, 310 (hereinafter referred to as target nodes 306, 310) to provide CHO configurations for target nodes 306, 310. The CHO configuration contains the radio protocol configurations that the UE 302 shall apply when handing over to a target cell of a target node 306, 310. In steps 324 and 325, the target nodes 306, 310 perform admission control and generate the CHO configurations that are provided back to the source node 304 in steps 326 and 327 via CHO request acknowledge. The source node 304 associates each CHO configuration for a prepared target cell with a CHO execution condition which refers to a measurement ID in source cell measurement configuration. The measurement ID links a measurement object (defining the frequency and quantity of the measurement (RSRP, RSRQ, etc) with a reporting configuration defining the parameters of the event (offset, TTT or thresholds) triggering the execution of CHO. For intra-frequency handover, the measurement event A3 is used, e.g., Mn>Ms+ Off where Mn is the measurement of neighboring cell, Ms is the measurement of a target cell and Off is an offset. Herein, the UE 302 will execute the CHO in case the condition above is met for a certain Time-to-Trigger (TTT). For inter-frequency HO, measurement event A5 can be used where the UE checks if the measurement of the serving cell falls below a threshold 1 and the measurement of the target cell is better than threshold 2 for certain TTT.

In step 328, the source node 304 sends the CHO configurations (RRC configurations) of the prepared target nodes 306, 310 along with their corresponding CHO execution. In step 329, the UE 302 evaluates the CHO execution condition and if one of them is met for a prepared target cell of the target node 306, 310 as shown in step 331, the UE 302 applies the corresponding CHO configuration and execute the handover as shown in steps 332 to 339. In step 339, the source node 304 cancels the CHO preparations of the target cells 310 that have not been used/applied by the UE for handover execution. The path switch from source node 304 to target node 306 is performed in step 20.

A NS-AoS may not match the cells of the whole TA, unlike the assumptions so far in NR for a network slice. In that case, the cells of the RAN nodes that are not part of the NS-AoS are configured with zero Radio Resources (e.g., Radio Resource Management (RRM) resources) for the slice by OAM. Thus, any service related to that particular slice cannot be served in the cell, although the RAN node still reports the slice as supported.

As discussed herein, the term “slice is supported and available” is interchangeable with “slice has more than zero RRM resources” in that cell. Alternatively, if “slice is supported but not available” then it has “zero RRM resources” in that cell.

If the UE is configured by the network with Conditional Handover, then currently the execution conditions consider only radio related aspects and do not take into account the NS-AoS support for an S-NSSAI. At the UE side, once a condition is met, then the UE selects the cell that meets the condition first and performs the handover towards that cell. However, it might occur that the selected cell does not have available resources for all or some of the slices that the UE is currently operating or allowed to operate with, because the cell is not within slice's NS-AoS. During conditional handovers, as the UE does not take into account NS-AoS of S-NSSAIs that the UE is currently using, it might occur that the UE selects a cell that does not have those S-NSSAIs available and as such the ongoing UE services might be interrupted since on those cells the S-NSSAI will be served with zero RRM resources.

The present disclosure seeks to optimize conditional handover and prevent these issues occurring. The present disclosure seeks to provide means to the UE to be able to identify if other conditions are met in addition to the basic CHO radio condition and to decide for alternative target cells which meet these conditions instead of deciding the target cell that first met the basic radio condition. These other conditions can include maximizing the slices that the UE uses and for which the slices are available and have more than zero RRM resources. The disclosure herein allows the UE, based on potential network indication, to steer itself to cells within NS-AoS during a CHO (i.e. a ‘self steering’ UE). Furthermore, another condition can also include that the serving cell is still above a certain threshold. Another condition can also include that the alternative target cell is within a certain pre-configured radio condition imbalance with the target cell that first met the basic radio condition.

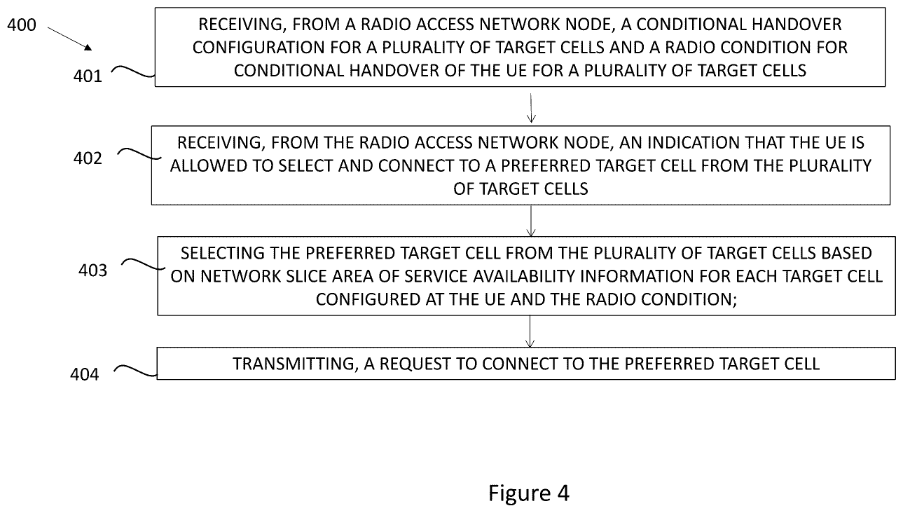

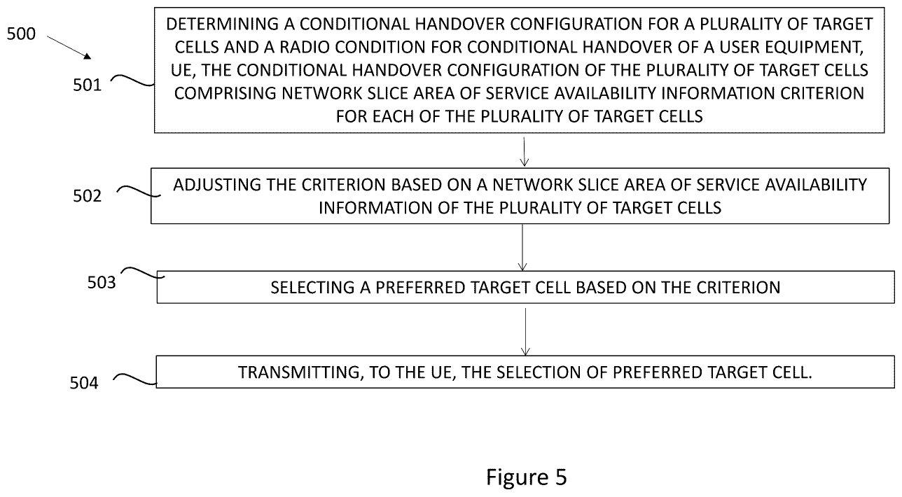

There are two alternatives presented for addressing the proposed problem. A UE based solution is presented (FIG. 4) and a radio access network node, RAN, based solution is also presented (FIG. 5). The UE solution and radio access network node solution may be combined together to provide a solution, or alternatively, only one of the UE based approach or the radio access network node-based approach can be used on their own to provide a solution.

FIG. 4 shows, by way of example, a flowchart of a method according to example embodiments. Each element of the flowchart may comprise one or more operations. The operations may be performed in hardware, software, firmware or a combination thereof. For example, the operations may be performed, individually or collectively, by a means, wherein the means may comprise at least one processor; and at least one memory storing instructions that, when executed by the at least one processor, cause the performance of the operations.

The method 400 may be carried out by a UE. The method 400 may comprise a first operation 401 of receiving, from a radio access network node, a conditional handover configuration for a plurality of target cells and a radio condition for conditional handover of the UE for a plurality of target cells. The conditional handover configuration may comprise for one or more target cells the CHO execution condition for the target cell.

The method 400 may comprise a second operation 402 of receiving, from the radio access network node, an indication that the UE is allowed to select and connect to a preferred target cell from the plurality of target cells.

The method 400 may comprise a third operation 403 of selecting the preferred target cell from the plurality of target cells based on network slice area of service availability information for each target cell configured at the UE and the radio condition (e.g., CHO condition). This means that a self-steering mechanism has been enabled to allow the UE to select and connect to its preferred target cell without involvement of the radio access network node. This is advantageous as it allows the UE to perform the subsequent method steps without involvement of the network. The main purpose of this feature is to allow the UE based on potential network indication to steer itself to cells within network slice area of service, NS-AoS, during a CHO.

The NS-AoS may comprise the area where the UE can access a service of a particular network slice. In some embodiments, accessing a service of a particular network slice means that the particular network slice is configured with more than zero resources in a particular cell. The network slice area of service availability information for a target cell may comprise information indicating availability or unavailability of at least one network slice at the target cell wherein the at least one network slice is unavailable at the target cell when the at least one network slice is configured with zero resources at the target cell.

The method 400 may comprise a fourth operation 404 of transmitting, a request to connect to the preferred target cell. Optionally, after receiving the request to connect to the preferred target cell, the connection may be established.

The method may be performed by a user device or UE such as the UE 100 of FIG. 1. The user device, or user equipment UE, typically refers to a portable computing device that includes wireless mobile communication devices operating with or without a subscriber identification module (SIM), including, but not limited to, the following types of devices: a mobile station (mobile phone), smartphone, personal digital assistant, handset, device using a wireless modem (alarm or measurement device, etc.), laptop and/or touch screen computer, tablet, game console, notebook, a vehicle, fixed wireless access (FWA) and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction.

In some embodiments, the method 400 may further comprise receiving a mapping between a physical cell identifier and a global cell identifier for at least one of the plurality of target cells. Optionally, the mapping is received in a system information block, SIB, sent by the radio access network node.

In some embodiments, the method 400 may further comprise receiving, from the radio access network node, power imbalance information for each of the plurality of target cells. The power imbalance information comprises a power difference which the UE can tolerate when comparing a power difference between a first target cell that fulfils at least one CHO radio condition criteria with a second target cell that fulfils the at least one CHO radio condition criteria, wherein the second target cell has more slices available compared to the first target cell. This power imbalance information can assist the UE in its algorithm of steering itself to a cell within NS-AoS.

Two radio access network node-based options are presented herein. Firstly, a ‘ranking’ based approach and, secondly, a ‘time based’ approach. Both methods are discussed herein. Each of the ‘ranking’ approach and ‘time-based approach’ can be applied together or individually to the method.

In some embodiments, the method 400 may further comprise determining whether in a first target cell one or more network slices of the UE are available based on the network slice area of service availability information for the first target network cell. Availability information may include a determination of whether a proposed target cell is available. In other words, if a network slice is available in the target cell then it is configured with more than zero RRM resources. If a network slice is not available in the target cell then it is configured with zero RRM resources in that particular cell.

In some embodiments, the method 400 may further comprise, upon determining that the first target cell one or more network slices of the UE are not available, searching for a second target cell from the plurality of target cells. The method 400 may also comprise determining whether the second target cell satisfies at least one radio condition and determining whether the second target cell has more network slices available than the first target cell.

Upon determining that the second target cell satisfies the at least one radio condition and determining that the second target cell has more network slices available than the first target cell, the method 400 may comprise selecting the second target cell and connecting to the second target cell. Alternatively, upon determining that the second target cell does not satisfy the at least one radio condition and/or determining that the second target cell does not have more network slices available than the first target cell, the method 400 may comprise selecting the first target cell and connecting to the first target cell.

In some embodiments, the method 400 may comprise, upon determining that the one or more network slices of the UE are not available in the first target cell, ranking the plurality of target cells based on the plurality of cells being available within at least one of the following:
all network slices allowed by a core network for the UE are available;
a maximum number of network slices allowed by the core network for the UE are available compared to the other target cells;
network slices categorized as having a high network priority;
network slices categorized as having a high priority network slice access stratum group, NSAG;
network slices categorized as having a high UE priority.

This is herein known as the ‘ranking’ approach.

High priority may include a value assigned by the network for a particular network slice based on SLAs or OAM configuration. A higher priority value means that a network slice needs to be treated with higher priority compared to lower priority slices. For instance, more radio resources could be provided to a cell of a radio access network node for a slice with higher priority. Alternatively, priority can be identified by existing NSAG priority that are used for a group of network slices for UE cell reselection algorithm. Another example of priorities could be for instance user priorities for a network slice. In that case, each user may assign and indicate to the radio access network node a value of priority associated with a certain network slice.

After ranking the targets cells, the method 400 may further comprise selecting a third target cell and connecting to the third target cell, the third target cell having the highest ranking. The highest ranking may be determined by applying a score factor depending on the ranked factors or by any other reasonable means for determining a rank (e.g. weighted average).

In some embodiments, the method 400 may further comprise, upon determining that at the first target cell one or more network slices of the UE are not available, determining a current cell that the UE is connected to and periodically assessing whether the current cell meets a predetermined threshold value for at least one radio condition. This is herein known as the “time-based approach”.

The predetermined threshold may be a measure of power Imbalance or if the radio conditions of the current cell that the UE is connected to start to degrade. In one example, this could be out of sync indicators received by lower layers. In another example degradation of radio conditions are related to the start of uplink retransmissions or uplink retransmissions reach a certain preconfigured number at the UE.

In some embodiments, the method may further comprise, upon determining that the current cell does not meet the predetermined threshold value for the at least one radio condition, selecting and connecting to a fourth target cell of the plurality of cells.

In some embodiments, the RAN node may or may not be aware of NS-AoS and the RAN node may or may not arrange thresholds/offsets of the events in the CHO conditions to prioritize cells that have available/support all or the maximum number of the slice(s) of the UE based on NS-AoS information.

FIG. 5 shows, by way of example, a flowchart of a method according to example embodiments. Each element of the flowchart may comprise one or more operations. The operations may be performed in hardware, software, firmware or a combination thereof. For example, the operations may be performed, individually or collectively, by a means, wherein the means may comprise at least one processor; and at least one memory storing instructions that, when executed by the at least one processor, cause the performance of the operations.

The method 500 may comprise a first operation 501 of determining a conditional handover configuration for a plurality of target cells and a radio condition for each target cell in the plurality of target cells for conditional handover of a user equipment, UE, the conditional handover configuration of the plurality of target cells comprising network slice area of service availability information criterion for each of the plurality of target cells.

The method may be performed by a network node, such as a radio access network, RAN, base station.

The method 500 may comprise a second operation 502 of adjusting the criterion based on the network slice area of service availability information of the plurality of target cells.

The method 500 may comprise a third operation 503 of selecting a preferred target cell based on the criterion.

The method 500 may comprise a fourth operation 504 of transmitting, to the UE, the selection of preferred target cell.

In some embodiments, the method 500 may further comprise receiving an indication of network slice availability for the plurality of target cells from an access and mobility management function.

In some embodiments, the method 500 may further comprise adjusting the criterion is based on the preferred target cell being available within at least one of the following:
all network slices allowed by a core network for the UE are available;
a maximum number of network slices allowed by the core network for the UE available compared to the other target cells;
network slices categorized as having a high network priority;
network slices categorized as having a high priority network slice access stratum group;
network slices categorized as having a high UE priority.

In some embodiments, the method 500 may further comprise transmitting, to the user equipment, information required to complete a conditional handover to the selected preferred cell.

In some embodiments, the method 500 may further comprise receiving a mapping between a physical cell identifier and a global cell identifier for at least one of the plurality of target cells. The mapping may be received in a system information block, SIB, sent by the radio access network node.

In some embodiments, the method 500 may further comprise determining power imbalance information for each of the plurality of target cells. Determining the power imbalance may comprise the same approach as previously discussed for the user equipment-based approach.

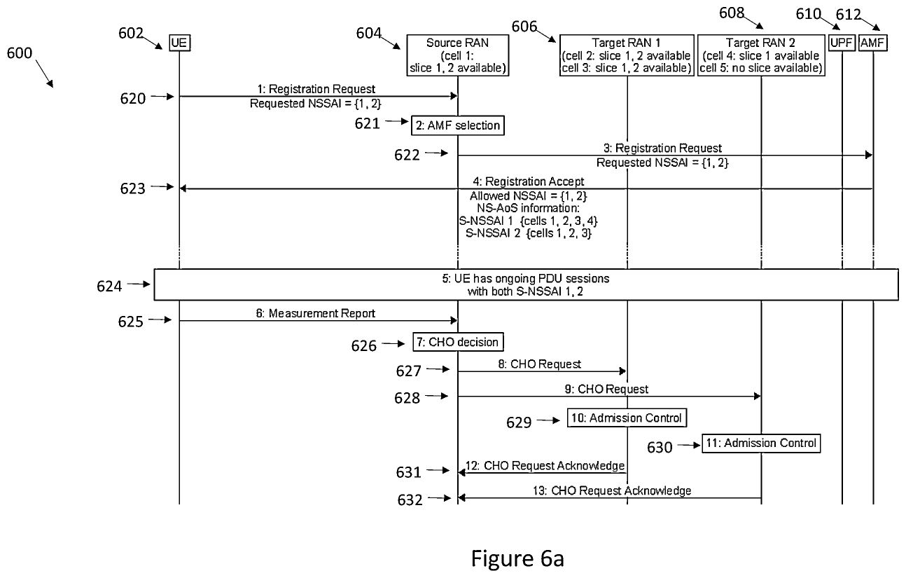

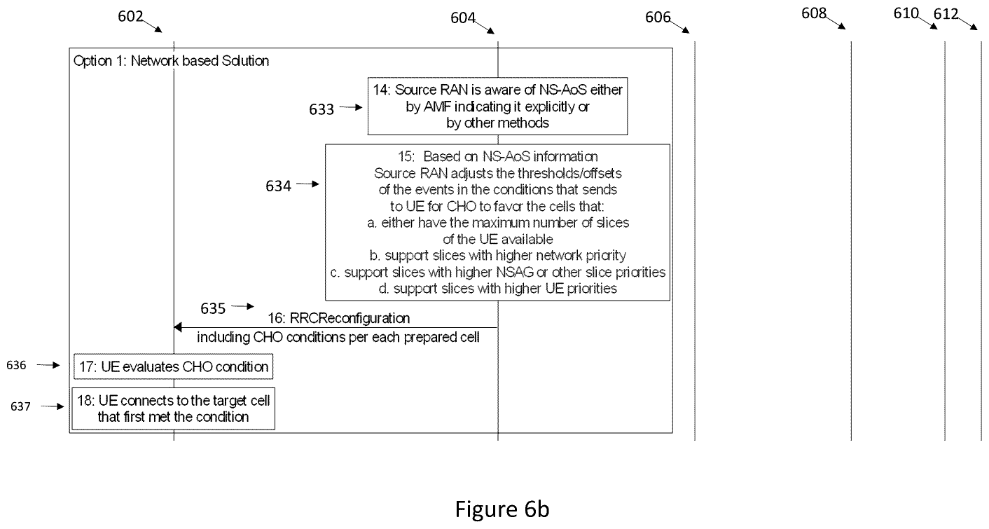

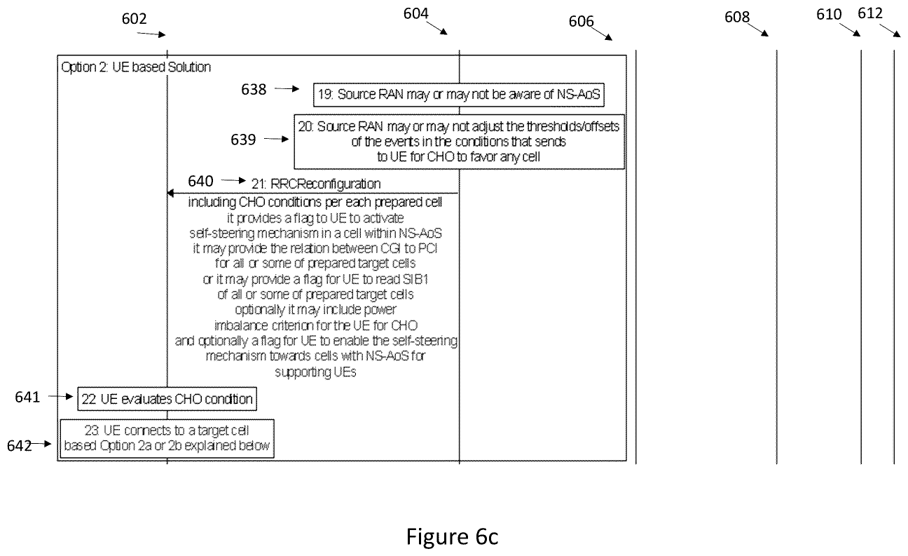

A system, comprising the user equipment suitable for performing the method of FIG. 4 and the radio access network node suitable for performing the method of FIG. 5 may also be provided. Such a system is shown by way of example in FIG. 6.

FIG. 6A-C shows a structure for the system including a UE 602, a radio access network node 604 (herein known as source RAN node), target RAN nodes 606, 608, a user plane function (UPF) 610 and AMF 612. FIG. 6B is a continuation of FIG. 6A and FIG. 6C is a continuation of FIG. 6B.

At a first step 620, the UE 602 sends a registration request to source RAN node 604 that serves the UE 602. Registration request may contain requested slices of the UE in requested NSSAI, such as slices 1,2. At step 621 the source RAN node 604 selects the appropriate AMF and at step 622 forwards the registration request. The source RAN node 604 forwards also the requested NSSAI from the UE 602 to AMF 612. At step 623, the AMF 612 forwards the registration accept message to the UE 602. The AMF 612 may also forward the Allowed NSSAI to the UE 602. Moreover, the AMF 612 may forward the NS-AoS to the UE 602 that includes for each S-NSSAI the cells where the respective S-NSSAI is available. In the example shown in FIG. 6A slice 1 is not available (e.g., zero radio resources) in cell 5, whereas slice 2 is not available (e.g., zero radio resources) in cells 4,5. That means cell 5 has zero radio resource available for any of UE's slices.

Step 624 shows that the UE 602 has ongoing PDU session(s) with slices 1 and 2. At steps 625 the UE 602 provides radio link measurement to Source RAN node 604. Based on the measurements provided by the UE the source RAN node takes a CHO decision, see step 626.

At steps 627 to 632, the source RAN node 604 sends to target RAN node 1 606 and target RAN node 2 609 a CHO Request message. Both target RAN node 1 606 and target RAN node 2 608 perform admission control and reply to source RAN node 604 with CHO Request acknowledge message.

FIG. 6B shows the network-based side of the solution, as detailed in FIG. 5 and discussed herein. At step 633, source RAN node 604 is aware of NS-AoS for the UE 602 either based on explicit indication from AMF 612 or by other methods. At step 634, based on NS-AoS information, the source RAN node 604 adjusts the thresholds/offsets of the events in the CHO execution conditions such that the UE 602 prioritizes target cells in the handover according to a ranking based as previously discussed herein.

At step 635, source RAN node 604 configures the UE 602 with CHO configuration and CHO conditions for each of the prepared target cell using RRCReconfiguration message. At steps 636 and 637, UE 602 evaluates the CHO conditions and selects and connects to the prepared target cell of target RAN nodes 606 or 608 that first met the condition.

FIG. 6C shows the UE side of the solution, as detailed in FIG. 4 and discussed herein.

At step 638, source RAN node 604 may or may not be aware of NS-AoS. At step 639, source RAN node 604 may or may not adjust the thresholds/offsets of the events in the CHO execution conditions for each of the target cells for the UE.

At step 640, source RAN node 604 configures the UE 602 with CHO configuration and CHO conditions for each of the prepared target cells using RRCReconfiguration message. The source RAN node 604 indicates with a flag set to True to the UE that self-steering mechanism is enabled. The self-steering mechanism allows the UE to select and determine its own choice of preferred target cell. The self-steering mechanism may also allow the UE 602 to connect to the selected target cell. RAN node may indicate in RRCReconfiguration message to the UE the relation between Physical Cell ID (PCI) and Cell Global ID (CGI) for the prepared target cells to assist the UE in the self-steering mechanism as the assumption is that NS-AoS is sent to UE given the global cell identifier CGI information, whereas the UE 602 is given the CHO configuration based on the physical cell identifier PCI information. The source RAN node 604 may send to the UE 602 the PCI to CGI relation for all or some of the prepared target cells. Alternatively, the RAN node may indicate with a flag set to True to the UE via RRCReconfiguration message to read SIB1 of the prepared target cells during measurement to learn the PCI to CGI relation to assist the UE in the self-steering mechanism. The source RAN node 604 may request the UE 602 to read SIB1 of all or some of the prepared target cells.

Optionally source RAN node 604 provides power imbalance criterion for comparing an alternative prepared target cell to the first target cell that meets a CHO condition to assist the UE in self-steering within NS-AoS. Optionally source RAN node 604 sends a flag for UE 602 to enable the self-steering mechanism towards cells with NS-AoS for supporting UEs 602. If the criterion for power imbalance is not provided, the prioritization can be performed by the UE 602 in implementation specific for the case when more than one target cell meet the CHO condition at the same time.

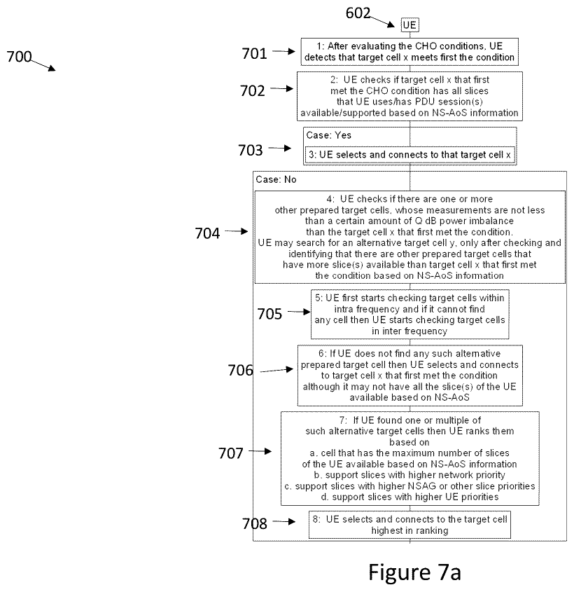

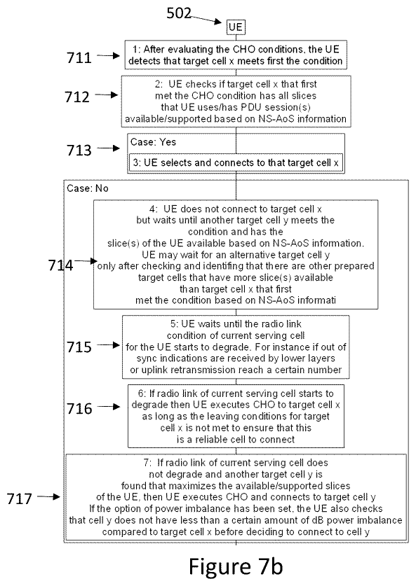

At steps 641 and 642, UE 602 evaluates the CHO conditions for each of the prepared target cells and selects and connects to the preferred target cell. As previously discussed, there are two options for how the UE 602 may connect to the preferred target cell—the ‘ranking’ based approach discussed herein in relation to FIG. 7A and the ‘time-based’ approach discussed herein in relation to FIG. 7B. Each of the ‘ranking’ approach and ‘time-based approach’ can be applied together or individually to the method.

FIG. 7A shows an example embodiment of a flowchart 700 of how the ‘ranking’ based approach may be applied. Each element of the flowchart may comprise one or more operations. The operations may be performed in hardware, software, firmware or a combination thereof. For example, the operations may be performed, individually or collectively, by a means, wherein the means may comprise at least one processor; and at least one memory storing instructions that, when executed by the at least one processor, cause the performance of the operations.

At step 701, a UE 602 evaluates the CHO conditions for each of the prepared target cells and identifies the prepared target cell ‘X’ first met a radio condition (e.g., CHO condition). At step 702, UE 602 checks if the target cell ‘X’ that first met the radio condition has available the slice(s) of the UE based on NS-AoS information and the CGI to PCI relation either received from RAN node or while reading SIB1. If the target cell ‘X’ that first met the radio condition provides availability for the slices of the UE, then at step 703 the UE 602 executes the CHO and connects to that target cell ‘X’.

Alternatively, if the target cell ‘X’ that first met the radio condition does not provide availability for the slice(s) of the UE, as shown in steps 704 and 704, the UE 602 checks if there is another prepared target cell ‘Y’ or multiple prepared target cells ‘Y1’, ‘Y2’ etc. that fall within a window compared to the radio conditions of target cell ‘X’ or the strongest neighbor cell measurement on a particular frequency (for instance less than as certain distance from dB). Wherein, fall within a window compared to the radio conditions may refer to the power imbalance threshold. Optionally, UE 602 may search for an alternative target cell ‘Y’, only after checking and identifying that there are other prepared target cells that have more slice(s) available than target cell ‘X’ that first met the radio condition based on NS-AoS information. The UE 602 may initially start to find alternative prepared target cells in intra frequency and then expand the search to cells in the inter frequency. Furthermore, a power imbalance indication may come from the network when UE 602 is configured with CHO conditions to allow a self-steering mechanism, as shown in item 640 of FIG. 6C or by UE implementation.

At step 706, if the UE 602 does not find such an alternative target cell, then UE 602 selects the target cell ‘X’ that first met the condition.

At step 707, otherwise, if UE 602 finds another target cell ‘Y1’, ‘Y2’ etc, it ranks them based on features such as: all network slices allowed by a core network for the UE are available, a maximum number of network slices allowed by the core network for the UE are available compared to the other target cells, network slices categorized as having a high network priority, network slices categorized as having a high priority network slice access stratum group, NSAG and network slices categorized as having a high UE priority. At step 708, the UE 602 selects and connects to the preferred target cell with higher ranking.

FIG. 7B shows an example embodiment of a flowchart 700 of how the ‘time-based’ approach may be applied. Each element of the flowchart may comprise one or more operations. The operations may be performed in hardware, software, firmware or a combination thereof. For example, the operations may be performed, individually or collectively, by a means, wherein the means may comprise at least one processor; and at least one memory storing instructions that, when executed by the at least one processor, cause the performance of the operations.

The steps of FIG. 7B may be applied independently from the steps of FIG. 7A or immediately before or after the steps of FIG. 7A.

At step 711, the UE 602 evaluates the CHO condition for each of the prepared target cells and identifies the prepared target cell ‘X’ first met the condition. At step 712, the UE 602 checks if the target cell ‘X’ that first met the condition provides availability for the slice(s) of the UE based on NS-AoS information and the CGI to PCI relation either received from RAN node or while reading SIB1.

If the target cell ‘X’ that first met the condition provides availability for the slice(s) of the UE, then at step 713 the UE 602 executes the CHO and connects to that target cell ‘X’.

Alternatively, if the target cell ‘X’ that first met the condition does not provide availability for the slice(s) of the UE, as shown in steps 714 and 715 and alternatively from the option described above in in relation to FIG. 7A, the UE 602 waits to find another target cell ‘Y’ that meets the radio condition and has available the slices of the UE 602. The UE 602 can wait until the radio link condition of the current serving cell starts to degrade (if out of sync indications are received by lower layers or uplink retransmissions start or uplink retransmissions reach a certain number). The UE 602 may wait for an alternative target cell ‘Y’, only after checking and identifying that there are other prepared target cells that have more slice(s) available than target cell ‘X’ that first met the condition based on NS-AoS information.

At step 716, if the radio link of the current serving cell starts to degrade the UE executes CHO to target cell ‘X’. For example, as long as the leaving conditions of target cell ‘X’ is not met to ensure that this is a reliable cell to handover to the new cell.

Alternatively, at step 717, if the radio link of the current serving cell does not degrade and in the meantime the UE finds another prepared target cell y that maximizes the slice(s) of the UE available based on NS-AoS then UE executes CHO and connects to target cell ‘Y’. If the option of power imbalance has been set, the UE also checks that cell ‘Y’ does not have less than a certain amount of dB power imbalance compared to target cell ‘X’ before deciding to connect to cell ‘Y’. In other words, a power imbalance check is performed before connecting to target cell ‘Y’.

### Example Apparatus

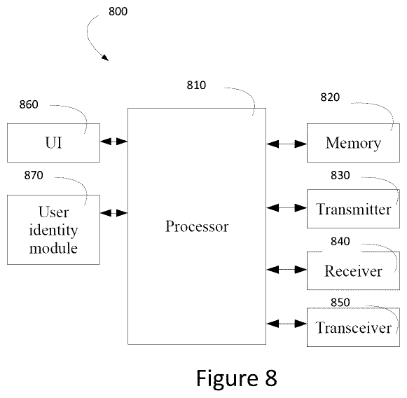

FIG. 8 shows, by way of example, a block diagram of an apparatus capable of performing the method(s) as disclosed herein. Illustrated is device 800, which may comprise, for example, a mobile communication device such as mobile 100 of FIG. 1. Comprised in device 800 is processor 810, which may comprise, for example, a single- or multi-core processor wherein a single-core processor comprises one processing core and a multi-core processor comprises more than one processing core. Processor 810 may comprise, in general, a control device. Processor 810 may comprise more than one processor. Processor 810 may be a control device. A processing core may comprise, for example, a Cortex-A8 processing core manufactured by ARM Holdings or a Steamroller processing core designed by Advanced Micro Devices Corporation. Processor 810 may comprise at least one Qualcomm Snapdragon and/or Intel Atom processor. Processor 810 may comprise at least one application-specific integrated circuit, ASIC. Processor 810 may comprise at least one field-programmable gate array, FPGA. Processor 810 may be means for performing method steps in device 800. Processor 810 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or a network node, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 800 may comprise memory 820. Memory 820 may comprise random-access memory and/or permanent memory. Memory 820 may comprise at least one RAM chip. Memory 820 may comprise solid-state, magnetic, optical and/or holographic memory, for example. Memory 820 may be at least in part accessible to processor 810. Memory 820 may be at least in part comprised in processor 810. Memory 820 may be means for storing information. Memory 820 may comprise computer instructions that processor 810 is configured to execute. When computer instructions configured to cause processor 810 to perform certain actions are stored in memory 820, and device 800 overall is configured to run under the direction of processor 810 using computer instructions from memory 820, processor 810 and/or its at least one processing core may be considered to be configured to perform said certain actions. Memory 820 may be at least in part external to device 800 but accessible to device 800.

Device 800 may comprise a transmitter 830. Device 800 may comprise a receiver 840. Transmitter 830 and receiver 840 may be configured to transmit and receive, respectively, information in accordance with at least one cellular or non-cellular standard. Transmitter 830 may comprise more than one transmitter. Receiver 840 may comprise more than one receiver. Transmitter 830 and/or receiver 840 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 800 may comprise a near-field communication, NFC, transceiver 850. NFC transceiver 850 may support at least one NFC technology, such as NFC, Bluetooth, Wibree or similar technologies.

Device 800 may comprise user interface, UI, 860. UI 860 may comprise at least one of a display, a keyboard, a touchscreen, a vibrator arranged to signal to a user by causing device 800 to vibrate, a speaker and a microphone. A user may be able to operate device 800 via UI 860, for example to accept incoming telephone calls, to originate telephone calls or video calls, to browse the Internet, to manage digital files stored in memory 820 or on a cloud accessible via transmitter 830 and receiver 840, or via NFC transceiver 850, and/or to play games.

Device 800 may comprise or be arranged to accept a user identity module 870. User identity module 870 may comprise, for example, a subscriber identity module, SIM, card installable in device 800. A user identity module 870 may comprise information identifying a subscription of a user of device 800. A user identity module 870 may comprise cryptographic information usable to verify the identity of a user of device 800 and/or to facilitate encryption of communicated information and billing of the user of device 800 for communication effected via device 800.

Processor 810 may be furnished with a transmitter arranged to output information from processor 810, via electrical leads internal to device 800, to other devices comprised in device 800. Such a transmitter may comprise a serial bus transmitter arranged to, for example, output information via at least one electrical lead to memory 820 for storage therein. Alternatively to a serial bus, the transmitter may comprise a parallel bus transmitter. Likewise processor 810 may comprise a receiver arranged to receive information in processor 810, via electrical leads internal to device 800, from other devices comprised in device 800. Such a receiver may comprise a serial bus receiver arranged to, for example, receive information via at least one electrical lead from receiver 840 for processing in processor 810. Alternatively to a serial bus, the receiver may comprise a parallel bus receiver.

Processor 810, memory 820, transmitter 830, receiver 840, NFC transceiver 850, UI 860 and/or user identity module 870 may be interconnected by electrical leads internal to device 800 in a multitude of different ways. For example, each of the aforementioned devices may be separately connected to a master bus internal to device 800, to allow for the devices to exchange information. However, as the skilled person will appreciate, this is only one example and depending on the embodiment various ways of interconnecting at least two of the aforementioned devices may be selected.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

Implementations of any of the above-described blocks, apparatuses, systems, techniques or methods include, as non-limiting examples, implementations as hardware, software, firmware, special purpose circuits or logic, general purpose hardware or controller or other computing devices, or some combination thereof. Some embodiments may be implemented in the cloud.

It is to be understood that what is described above is what is presently considered the preferred embodiments. However, it should be noted that the description of the preferred embodiments is given by way of example only and that various modifications may be made without departing from the scope as defined by the appended claims.

1. A user equipment (UE) comprising:
at least one processor; and
at least one memory storing instructions which, when executed by the at least one processor, cause the UE to perform:
receiving, from a radio access network node, a conditional handover configuration for a plurality of target cells and a radio condition for conditional handover of the UE for a plurality of target cells,
receiving, from the radio access network node, an indication that the UE is allowed to select and connect to a preferred target cell from the plurality of target cells;
selecting the preferred target cell from the plurality of target cells based on network slice area of service availability information for each target cell configured at the UE and the radio condition; and
transmitting, a request to connect to the preferred target cell.

2. The user equipment as claimed in claim 1, wherein the instructions, when executed by the at least one processor, cause the UE to perform:
receiving a mapping between a physical cell identifier and a global cell identifier for at least one of the plurality of target cells.

3. The user equipment as claimed in claim 2, wherein the mapping is received in a system information block, SIB, sent by the radio access network node.

4. The user equipment as claimed in claim 1, wherein the network slice area of service availability information for a target cell comprises information indicating availability or unavailability of at least one network slice at the target cell wherein the at least one network slice is unavailable at the target cell when the at least one network slice is configured with zero resources at the target cell.

5. The user equipment as claimed in claim 1, wherein the instructions, when executed by the at least one processor, cause the UE to perform:
receiving, from the radio access network node, power imbalance information for each of the plurality of target cells.

6. The user equipment as claimed in claim 5, wherein the power imbalance information comprises a power difference which the UE can tolerate when comparing a power difference between a first target cell that fulfils at least one radio condition criteria with a second target cell that fulfils the at least one radio condition criteria, wherein the second target cell has more slices available compared to the first cell.

7. The user equipment as claimed in claim 1, wherein the selecting comprises:
determining whether, at a first target cell of the plurality of targets cells, one or more network slices currently in use or allowed to be used by the UE are available based on the network slice area of service availability information for the first target network cell.

8. The user equipment as claimed in claim 7, wherein the instructions, when executed by the at least one processor, cause the UE to perform:
upon determining that at the first target cell one or more network slices of the UE are unavailable,
searching for a second target cell from the plurality of target cells;
determining whether the second target cell satisfies the radio condition for the second target cell;
determining whether at the second target cell there are more network slices available than at the first target cell;
upon determining that the second target cell satisfies the radio condition and determining that the second target cell has more network slices available than the first target cell, selecting the second target cell and connecting to the second target cell, or
upon determining that the second target cell does not satisfy the radio condition and/or determining that the second target cell does not have more network slices available than the first target cell, selecting the first target cell and connecting to the first target cell.

9. The user equipment as claimed in claim 7, wherein the instructions, when executed by the at least one processor, cause the UE to perform:
upon determining that the one or more network slices of the UE are unavailable in the first target cell,
ranking the plurality of target cells based on the plurality of cells being available within at least one of the following:
all network slices allowed by a core network for the UE are available;
a maximum number of network slices allowed by the core network for the UE are available compared to the other target cells;
network slices categorized as having a high network priority;
network slices categorized as having a high priority network slice access stratum group, NSAG;
network slices categorized as having a high UE priority
selecting a third target cell and connecting to the third target cell, the third target cell having the highest ranking, and connecting to the third target cell.

10. The user equipment as claimed in claim 7, wherein the instructions, when executed by the at least one processor, cause the UE to perform:
upon determining at that the first target cell one or more network slices used or allowed to be used by the UE are unavailable,
determining a cell that the UE is connected to;
periodically assessing whether the cell meets a predetermined threshold value for the radio condition.

11. The user equipment as claimed in claim 10, wherein the instructions, when executed by the at least one processor, cause the UE to perform:
upon determining that the cell does not meet the predetermined threshold value for the radio condition, selecting and connecting to a fourth target cell of the plurality of cells.

12. A radio access network node, comprising:
at least one processor; and
at least one memory storing instructions which, when executed by the at least one processor, cause the radio access network node to perform:
determining a conditional handover configuration for a plurality of target cells and a radio condition for conditional handover of a user equipment (UE) the conditional handover configuration of the plurality of target cells comprising network slice area of service availability information criterion for each of the plurality of target cells;
adjusting the criterion based on a network slice area of service availability information of the plurality of target cells;
selecting a preferred target cell based on the criterion; and
transmitting, to the UE, the selection of preferred target cell.

13. The radio access network node as claimed in claim 12, wherein the instructions, when executed by the at least one processor, cause the UE to perform:
receiving an indication of network slice availability for the plurality of target cells from an access and mobility management function.

14. The radio access network node as claimed in claim 12, wherein the adjusting the criterion is further based on the preferred target cell being available within at least one of the following:
all network slices allowed by a core network for the UE are available;
a maximum number of network slices allowed by the core network for the UE are available compared to the other target cells;
network slices categorized as having a high network priority;
network slices categorized as having a high priority network slice access stratum group;
network slices categorized as having a high UE priority.

15. The radio access network node as claimed in claim 12, wherein the instructions, when executed by the at least one processor, cause the UE to perform:
transmitting, to the user equipment, information required to complete a conditional handover to the preferred target cell.

16. The radio access network node as claimed in claim 12, wherein the instructions, when executed by the at least one processor, cause the UE to perform:
receiving a mapping between a physical cell identifier and a global cell identifier for at least one of the plurality of target cells.

17. The radio access network node as claimed in claim 16, wherein the mapping is received in a system information block, SIB, sent by the radio access network node.

18. The radio access network node as claimed in claim 12, wherein the instructions, when executed by the at least one processor, cause the UE to perform:
determining power imbalance information for each of the plurality of target cells.

19. The radio access network node as claimed in claim 18, wherein the power imbalance information comprises a power difference which the UE can tolerate when comparing a power difference between a first target cell that fulfils at least one radio condition criteria with a second target cell that fulfils the at least one radio condition criteria, wherein the second target cell has more slices available compared to the first cell.

20. A non-transitory computer-readable medium storing instructions which, when executed by at least one processor of a user equipment, cause the user equipment to perform:
receiving, from a radio access network node, a conditional handover configuration for a plurality of target cells and a radio condition for conditional handover of the UE for a plurality of target cells,
receiving, from the radio access network node, an indication that the UE is allowed to select and connect to a preferred target cell from the plurality of target cells;
selecting the preferred target cell from the plurality of target cells based on network slice area of service availability information for each target cell configured at the UE and the radio condition; and
transmitting, a request to connect to the preferred target cell.
